(19) United States
(12) Patent Application Publication
(10) Pub. No.: US 2009/0259623 A1
(43) Pub. Date: Oct. 15, 2009

(54) Systems and Methods for Associating Metadata with Media

(75) Inventors: Mark Randall Mooneyham, Folsom, CA (US); William Hensler, Shoreline, WA (US)

Correspondence Address: Kilpatrick Stockton LLP- Adobe Systems, Inc. 58083, Kilpatrick Stockton LLP, 1100 Peachtree Street, Atlanta, GA, 30309-4530, US

(73) Assignee: Adobe Systems Incorporated, San Jose, CA (US)

(21) Appl. No.: 12/101,621

(22) Filed: Apr. 11, 2008

(51) Int. Cl. G06F 7/06; G06F 17/30

(52) U.S. Cl. 707/3; 707/103 R; 707/1; 707/E17.045; 707/E17.014

(57) ABSTRACT

Embodiments provide methods and systems for associating metadata with media. Such methods may involve associating a media identifier with a media, storing, in an index of media identifiers, one or more entries each comprising the media identifier and metadata associated with the media, and incorporating or preserving a reference to the media identifier in the media. Certain embodiments involve creating metadata during development of the media using, for example, an electronic media processing tool. Certain embodiments involve using a media identifier in media to retrieve or otherwise use metadata associated with the media, including metadata that is stored at another location such as in one or more entries of an index of media identifiers.

### FIELD

Embodiments of the present disclosure relate generally to metadata, including but not limited to metadata about media content, metadata identified during media development, and metadata stored outside of and/or remote from the file or media to which it relates.

### BACKGROUND

Rich media includes video, audio, interactive media, and other complex media. Such media are often opaque in the sense that the content, source, and rights of the media is difficult to identify. For example, an audio file may contain a speech that includes thousands of words and phrases that are not readily apparent from looking at the audio file itself Associating content, for example, the words of the speech, with the media often requires significant effort. Depending on the media and content involved, it may require manually transcribing audio, making users manually enter tags, using optical character recognition, using face detection and recognition, and/or using machine audio to text speech recognition, among other things. Such techniques for deriving or identifying content from a finished or published piece of media may also be complicated by the compressed nature of the media. Media is often compressed when it is published, for example, on the Internet, and such compression makes understanding or deriving information about the media more difficult. Techniques for deriving or identifying content may also be complicated where the media includes objects used or blended together, such as a speech mixed with background music.

In addition to these problems associated with deriving metadata (information about the media, how the media was made, rights in the media, etc.) from finished or published media, there are problems with using such data. For example, in some cases the media is of a type, e.g. a file type, that does not allow storage of embedded metadata. Note that the terms “media” and “piece of media” are used interchangeably herein.

### SUMMARY

Certain embodiments described herein provide methods and systems for associating metadata with media. Such methods may involve associating a media identifier with a piece of media, storing, in an index of media identifiers, one or more entries each comprising the media identifier and metadata associated with the media, and incorporating or preserving a reference to the media identifier in the media, such as the media identifier itself The media identifier may be different from media identifiers associated with other media, i.e., effectively unique for identification purposes. Certain embodiments involve creating metadata during development of the media on an electronic media processing tool. Certain embodiments involve using a media identifier incorporated in the media, for example as a watermark or as embedded metadata, to retrieve or otherwise use metadata associated with the media, including metadata that is stored at another location such as in an entry of an index of media identifiers.

One embodiment of the present disclosure is a method of associating metadata with media. The method comprises providing an electronic media processing tool for creating, modifying, or reviewing media. The method comprises identifying metadata during development of the media and determining a media identifier associated with the media. The media identifier may be different from media identifiers associated with other media. The method comprises providing the metadata and media identifier for storage in an index of media identifiers, the index of media identifiers providing access to metadata associated with the media identifier. The method comprises incorporating or preserving a reference to the media identifier in the media.

One embodiment of the present disclosure is a method of creating metadata during media development. The method comprises determining a media identifier associated with the media. The media identifier is different from media identifiers associated with other media. The method comprises identifying first stage metadata during a first stage of development of the media and providing the first stage metadata and media identifier for storage in an index of media identifiers. The index of media identifiers provides access to metadata associated with the media identifier. The method further comprises identifying second stage metadata during a second stage of development of the media and providing the second stage metadata and media identifier for storage in the index of media identifiers. The method also comprises incorporating or preserving a reference to the media identifier in the media.

One embodiment of the present disclosure is a method of providing a repository of metadata. The method comprises maintaining an index of media identifiers, at least some of the entries of the index comprising (a) a media identifier identifying media and (b) metadata associated with the media identified by the media identifier. The method also comprises receiving metadata associated with a first media. The method also comprises storing an entry in the index of media identifiers. The entry may comprise the metadata associated with the first media and a media identifier associated with the first media.

One embodiment of the present disclosure is a method of providing a repository of metadata. The method comprises maintaining an index of media identifiers, at least some of the entries of the index comprising (a) a media identifier identifying media and (b) metadata associated with the media identified by the media identifier. The method also comprises receiving metadata from an electronic media processing tool. Some of the metadata stored in the index may thus be metadata that is associated with development of media with the electronic processing tool. The method may also comprise storing an entry in the index of media identifiers. The entry may comprise the metadata from the electronic media processing tool and a media identifier associated with the media.

In other embodiments, a computer-readable medium (such as, for example, random access memory or a computer disk) comprises code for carrying out these methods.

These embodiments are mentioned not to limit or define the disclosure, but to provide examples of embodiments to aid understanding thereof Embodiments are discussed in the Detailed Description, and further description is provided there. Advantages offered by the various embodiments may be further understood by examining this specification.

### BRIEF DESCRIPTION OF THE FIGURES

These and other features, aspects, and advantages of the present disclosure are better understood when the following Detailed Description is read with reference to the accompanying drawings, wherein:

FIG. 1 is a system diagram illustrating an illustrative network environment according to certain embodiments;

FIG. 2 is a workflow diagram illustrating an illustrative development workflow according to certain embodiments;

FIG. 3 is a flow diagram illustrating an illustrative media development and use environment according to certain embodiments;

FIG. 4 is a flow chart illustrating a method of associating metadata with media according to certain embodiments;

FIG. 5 is a flow chart illustrating a method of creating metadata during media development according to certain embodiments;

FIG. 6 is a flow chart illustrating a method of providing a repository of metadata according to certain embodiments; and

FIG. 7 is a flow chart illustrating a method of searching for media using a search term.

### DETAILED DESCRIPTION

Certain embodiments of the present disclosure may receive or derive metadata for media as the media is developed and/or used. The captured or derived metadata may be stored in an index of media identifiers, such as a database made available over the Internet. Metadata stored in an index of media identifiers may have a media identifier that identifies the media with which the metadata is associated. An index of media identifiers may contain multiple entries for a given media made during the media's development project and/or use of the media that reflect information about the content of the media, how the media was made, rights in the media, and other metadata. In certain embodiments, each entry in the index of media identifiers includes the media identifier. This media identifier can be used to retrieve the metadata associated with the media from the index of media identifiers, and for a variety of other useful functions.

A media development project may result in the creation of media, such as a rich media file, that includes the media identifier, for example in a watermark, in the file's embedded metadata (if available), or otherwise. When the file is published or used at a later time, associated metadata may be retrieved by getting the media identifier from the media itself, for example by reading a watermark, embedded metadata, or analyzing fingerprinting characteristics of the media, and using the media identifier to retrieve the associated metadata from the index of media identifiers. One potential use for these techniques involves identifying media content by retrieving metadata about the media from the index of media identifiers and using the content to determine targeted advertising to be provided with the media. The index of media identifiers may also be searched for content to identify opaque media related to a given search or search term that would otherwise not be located in such a search.

### Illustrative Application of an Index of Media Identifiers

The following specific illustrative embodiment is provided to illustrate some of the applications, uses, and benefits of providing an index of media identifiers to store and provide metadata for media.

According to an embodiment, a movie is developed in a multistage development process. At an early stage of development, a script is generated that includes written comments about the various movie scenes (e.g., “the living room is a mess with banner making supplies across the floor. CLAIRE BENNET enters from the kitchen carrying her school books and a cell phone. She looks exhausted,”) and the actors' dialog (e.g., “CLAIRE I can't believe you forgot to get me . . . MR. BENNET Do you think you could forgive me if that shiny new BMW you want showed up in the driveway on your Birthday?”). In this example, several data points are of potential interest in the spoken dialog and the scene description. As examples, the identification of “living room,” “books,” and “cell phone” in the scene description and the identification of the car brand BMW in the dialog are of potential interest with respect to metadata that could be associated with the scene.

In this example, if a media identifier has not already been created for the movie being developed, then one is created. Once the media identifier is created, various metadata are identified and used to create entries in a metadata repository or database. For example, an entry may be created for each of “living room,” “books,” “cell phone,” and “BMW.” Alternatively, or in addition, one or more metadata entries could be created for larger portions of the script or even the entire script. The metadata entries that are created may be sent for storage in the metadata repository, if it is located remotely. This metadata is then available at a later development stage or during consumption of the media.

If the media does not already have the media identifier incorporated (e.g., as a watermark or embedded metadata) then the media identifier is incorporated in the media. During the course of development, the media may change forms. For example, at a later stage of development the script is used while filming the scenes of the movie, and in that sense the media has changed form from a script to a playable video.

During development, the media may be sent from one stage to another. For example, the video may be sent from a filming stage to an editing stage. In this case, one or more actual video files are sent to the editor for editing. During editing, the editor or application used for editing can access any metadata that has previously been associated with the media. For example, an editor can query the metadata repository for all metadata associated with the media identifier, which is incorporated in the media itself.

As another example, at a production, playback or advertising stage of development, metadata may be retrieved for the media, e.g., “living room,” “books,” “cell phone,” and “BMW,” and advertising related to such metadata may be provided with or inserted in the media. For example, the car manufacturer BMW may be willing to pay more than another advertiser to place their car advertisement with or as part of a video in which their car is seen or mentioned. Media may be altered to add advertisements if appropriate.

If the media is produced and made publicly available, the metadata from the repository may also be publicly available. A consumer may remember a particular line from a movie and could use the repository to search for that line. For example, a consumer might search for the phrase “shiny new BMW you want showed up in the driveway” and, if that phrase is found in the metadata for a piece of media, the consumer would be able to identify the media's media identifier and ultimately identify the movie and even the time position in the movie where the line appears, if such information is also captured in the metadata.

As an additional example, a consumer may watch a piece of media and want to associate metadata with the media. For example, a consumer may watch a video clip and identify a mysterious occurrence, such as something that looks like a ghost briefly appearing and then disappearing. The repository may be configured to allow the creator of the media identifier (i.e., the original creator or overseer of the media's development) to set permissions that allow or do not allow developers and/or consumers to add to or change metadata stored in the repository. In the present example, if the creator allows user added metadata, the consumer can send a new entry to the repository that associates the new metadata, e.g., “ghost” or “ghost captured on film,” with the media's media identifier. Similarly, the original developers may associate additional metadata after publication, for example, if they learn that one of the actors improvised and changed one of the lines in the original script.

These illustrative examples are given to introduce the reader to the general subject matter discussed herein and are not intended to limit the scope of the disclosed concepts. The following sections describe various additional embodiments and examples of methods and systems for using media and associated metadata.

### Illustrative Network Configuration

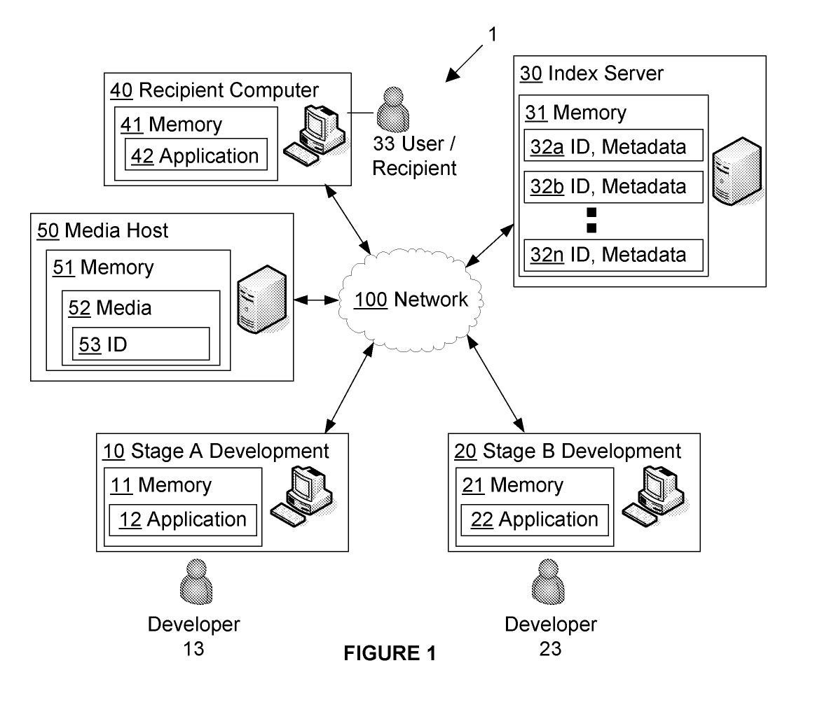

Referring now to the drawings in which like numerals indicate like elements throughout the several Figures, FIG. 1 is a system diagram illustrating an illustrative network environment according to certain embodiments. Other embodiments may be utilized. The environment 1 shown in FIG. 1 comprises a wired or wireless network 100 connecting various network devices 10, 20, 30, 40, 50. Applications that execute on each of the devices 10, 20, 30, 40, 50 are shown as functional or storage components residing in memory 11, 21, 31, 41, 51 on the respective devices. As is known to one of skill in the art, such applications may be resident in any suitable computer-readable medium and execute on any suitable processor. For example, the network devices 10, 20, 30, 40, 50 shown each may comprise a computer-readable medium such as a random access memory (RAM) 11, 21, 31, 41, 51, coupled to a processor that executes computer-executable program instructions stored in memory 11, 21, 31, 41, 51, 61. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

A computer-readable medium may comprise, but is not limited to, an electronic, optical, magnetic, or other storage or transmission device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. A computer-readable medium may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

The network 100 shown comprises the Internet. In other embodiments, other networks, such as an intranet, or no network may be used. Moreover, methods may operate within a single device. The devices 10, 20, 30, 40, 50 can be connected to a network 100 as shown. Alternative configurations are of course possible. The devices 10, 20, 30, 40, 50 may also comprise a number of external or internal devices such as a mouse, a CD-ROM, DVD, a keyboard, a display, or other input or output devices. Examples of devices that could execute a development application 12, 22 are personal computers, digital assistants, personal digital assistants, cellular phones, mobile phones, smart phones, pagers, digital tablets, laptop computers, Internet appliances, other processor-based devices, and television viewing devices. In general, a device may be any type of processor-based platform that operates on any operating system capable of supporting one or more client applications or media consuming programs.

The server devices 30, 50 depicted as single computer systems, may be implemented as a network of computers or processors. Examples of a server device are servers, mainframe computers, networked computers, a processor-based device, and similar types of systems and devices.

For FIG. 1, a stage A development device 10 with a first development application 12 in its memory 11 may be used by a developer 13 to perform some or all of the development of a piece of media. For example, the application 12 may be a script writing application for the developer 13 to enter a movie script. As another example, the application 12 could be an animating or compositing application that allows a developer to, among other things, incorporate graphics, video, or special effects from other sources, and then animate or combine the data with other content.

The stage A development application 10 may create a media identifier for the media that is being created. When metadata information is identified, such as words of a script or data incorporated from another source, the stage A development information may generate a metadata entry to be stored for later use. For example, the metadata entry may be sent through the network 100 to an index server 30 and stored as a memory 31 entry. Generally, the metadata entry will comprise the media identifier and the metadata. It may comprise additional information as well, such as time of capture, etc. To reduce network load, several entries may be stored on the local computer and sent to the index of media identifiers server in a combined batch. The index of media identifiers server may store multiple entries 32a-n for a single media. Each such entry could have the same media identifier. The development application 12 may incorporate the media identifier in the media, for example, as a watermark or embedded metadata.

Similar to the first development application 10, a second development application 22 used on the same 10 or another machine, such as stage B development device 20, may be used by a developer 23 to perform some or all of the development of a piece of media. As an example, if development of a piece of media is begun on the stage A development device, the development of the media may be continued on the stage B development device 20. The media, for example in the form of a file, may be sent to the development application 22 on the stage B development device 20. The development application 22 may find the incorporated media identifier incorporated in the media and use the media identifier to retrieve any needed metadata from the index server 30. The development application 22 may also identify or create additional metadata to be added to the index server 30. For example, the development application 22 may add a song to an already created presentation. Metadata, such as the lyrics of the song, may be identified by the development application 22, or the developer 23, and an appropriate entry or entries may be made on the index server 30.

At the conclusion of development, the media may be published on a media hosting device 50 for consumption by end users 33. For example, if the finished media is a movie, a video file 52 may be stored in the memory 51 of a media host server 50. The media 52 on the media host server 50 may comprise the media identifier 53 assigned and used by the development devices 10, 20. Note that assignment of the media identifier may be made by the index of media identifiers server or other central processing device. For example, when a development application needs a new media identifier, it could derive it internally or send a request to an appropriate device to receive such a media identifier.

The media host server 50 may provide the media to one or more requesting devices or otherwise. For example, a user/recipient 33 on a recipient device 40 may request the media 52. For example, if the media is a movie file, the user may request to download, stream, or otherwise consume the media. In the case where the media identifier 53 is incorporated in the media 52, the user 33 can access (or modify if they have sufficient privileges) the metadata stored for the media 52 on the index server 30 as metadata entries 32a-n.

### Illustrative Media Development and Distribution Processes

The development of a piece of media can vary significantly depending on the type and content of the media being developed. In many cases, media development involves multiple steps performed by multiple developers and involves the use of multiple content capturing, importing, editing, and distributing tools. However, development of certain media can be relatively simple and involve a single developer using a single tool to develop a relatively simple piece of media.

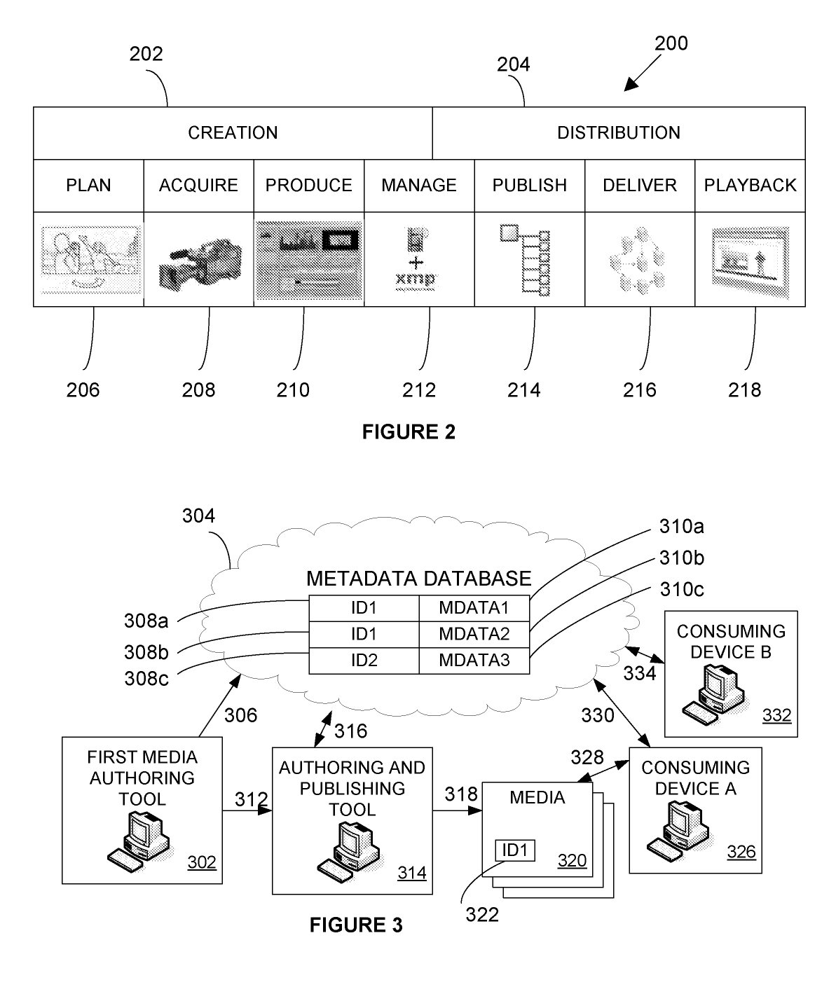

FIG. 2 is a workflow diagram illustrating an illustrative development workflow according to certain embodiments. In this example, the development workflow 200 comprises two general phases: creation 202 and distribution 204. Generally, as the development stages progress, information from prior stages, that was not stored as metadata during that stage's development, is lost or degraded in quality. Similarly, generally, as the development stages progress, the cost and/or complexity increases for extracting metadata from prior development stages.

The creation phase 202 of the production workflow 200 may involve a plan stage 206, an acquire stage 208, a produce stage 210, and all or part of a manage stage 212. In this example, the plan stage 206 involves one or more developers planning the content that will be included in the media, such as the development of a screenplay. The acquire stage 208 may involve capturing or importing content to be included in the piece of media. For example, content may be captured by a still camera, video camera, microphone, or other content capturing device or imported from another source, for example, by importing a photo, video, presentation, data, or other content. The produce stage 210 can involve a variety of editing and other producing tasks performed by one or more developers. The manage stage 212 can involve final editing and preparing of the media for distribution.

The distribution phase 204 may continue the manage stage 212 and further involve a publish stage 214, a deliver stage 216, and a playback stage 218. In this case, the manage stage 212 can finalize the media for distribution. The publish stage 214 may provide the media to a third party or on a media serving device, for delivery to end consumers. At the deliver stage 216, the media is delivered to one or more consumers. Any suitable delivery technique may be used, including, but not limited to, delivery in response to consumer request, delivery over a network, delivery on a disk or portable media container, and delivery to an e-mail account, as examples. Once the media has been provided to the end consumer, the consumer, at the playback stage 218, is able to view or otherwise consume the media.

### Illustrative Metadata Repository

FIG. 3 is a flow diagram illustrating an illustrative media development and use environment according to certain embodiments. In this example, a metadata repository or database 304 is used to facilitate metadata use. The first media processing tool 302 may be a rich media, text editor, audio or video editor, or any other suitable tool. The first media processing tool 302 comprises technology that receives metadata with its input content and/or derives metadata as content is created using the tool 302. The media output 312 of the media processing tool 302 is media in a first form, such as a file, in which a media identifier is incorporated, for example as embedded metadata or as a watermark, or preserved, for example, as a fingerprint. Because techniques such as fingerprinting may not change the media (e.g., a fingerprint may be derived from the existing media through analysis of pre-existing characteristics such as the color or brightness changes between frames), the media may be given a media identifier such as a derived fingerprint without changing the media file itself. The media identifier may be created by the first media processing tool 302 or may be provided by a media identifier generator (not shown).

As metadata is identified or created by the first media processing tool 302, one or more metadata entries 306 are sent to the metadata database 304. For example, a first entry comprising the media identifier of a first piece of media 308a and metadata 310a associated with that first piece of media may be sent to and stored in the metadata database 304. Similarly, another entry comprising the media identifier of a first piece of media 308b and different metadata 310b associated with that first piece of media may be sent to and stored in the metadata database 304. When the first media processing tool 302 is used to generate a different piece of media, a new media identifier may be created, and a third entry comprising the new media identifier of a second piece of media 308c and metadata 310c associated with that second piece of media may be sent to and stored in the metadata database 304.

Thus, in certain embodiments, a media identifier is created for a given media output 312 of the first media processing tool 302 and stored with metadata in a centralized or decentralized database 304. The media identifier is incorporated or otherwise provided with the media output 312 that is generated by the first media processing tool 302. The metadata that is stored in the database 304, such as metadata 310a-c, may also be embedded in media output 312 itself.

In certain embodiments, the metadata database 304 is used as a centralized repository for metadata of media (and other objects). The database may be accessible on the Internet, to a limited work group, or otherwise made available to select groups of people. The database may be located on the developer's machine. In the case of multiple databases existing simultaneously, for example, on a developer's machine, at the workgroup level and a publicly available index of media identifiers, each database can replicate entries by communicating with the others and transferring the entries.

The media output 312 produced by the first media processing tool 302 may not be in final production form. One or more additional processing tools may be used to modify the media output 312 with the addition or modification of content, and may be used to identify and create additional metadata associated with the media output 312. For example, authoring and publishing tool 314 may take the media output 312 of the first media processing tool 302 as input. The authoring and publishing tool 314 can identify and use the media identifier incorporated in the media output 312. For example, authoring and publishing tool 314 can look up the metadata that is already associated with the media output 312 by sending and receiving communication 316 with the metadata database 304. Similarly, as authoring and publishing tool 314 is used to create or modify the content of the media, additional metadata may be identified and used to send additional entries to the metadata database 304.

The metadata created or identified at any stage of development or use may include information about the content, about the development of the content, about the source of the content, about author rights, about usage rights, and/or about any other topic for which metadata information may be useful.

The output 318 of authoring and publishing tool 314 may be a finalized media 320 that incorporates the media identifier 322 associated with the media's metadata in the metadata database 304. The media 320 may be in the same form as the media output of the first media processing tool 312, or may be in a completely different form. For example, the media output 312 of the first media processing tool may be a computer file having a text format that includes the script and scene information for a movie and the media 320 may be a video format file. As described above, development of a piece of media may involve multiple steps performed by multiple developers and the use of multiple content capturing, importing, editing, and distributing tools.

In FIG. 3, the finalized media 318 is made available to end consumers. In this example, a consuming device A 326 downloads the media 320 and plays the media for an end consumer. The consuming device A 326 is further used to retrieve metadata, for example, the script of the video, by the consuming device. This retrieval can be achieved in a variety of suitable ways. For example, the consuming device A 326 may send and receive communications 330 with the metadata database 304 requesting metadata associated with the media's media identifier 322.

Another consuming device B 332 may perform a search by sending and receiving communications 334 with the metadata database 304. For example, an end user may search for content that includes a particular actor and the search may send a message 334 to the metadata database 304 asking for the media identifiers for all metadata that includes the actor's name. In response, the consumer device B 332 may receive one or more media identifiers, which may be used to locate or provide a list of media to which the media identifiers relate. For example, a standard Internet search for the one or more media identifiers may return media that has the media identifier incorporated (e.g., as a watermark or as embedded metadata).

A consuming device may be used to play back, deliver, and/or serve media content. Examples include a device with Adobe(g Flash(g software, a device using the Adobe® AIR® platform, a device using an Adobe(g Acrobat(g product, a set top box, or other media consuming fixed or portable devices. Such a component may play back media, get the incorporated media identifier from the media when necessary, and look up metadata when necessary. A consumption device could be a server that is serving out the media. In one embodiment, such a server device, retrieves metadata for a piece of media and from the metadata identifies the subject matter of the media, e.g., that the media relates to hot rod cars. Another consumption device may be a social media web site which uses the digital identifier to look up usage rights information to determine if it has permission to distribute media files uploaded to it. The server device uses this information to serve media with one or more advertisements about cars. Thus, a metadata lookup could happen on either or both the delivery side or playback side of media consumption. In some embodiments, it may be desirable to cache copies of the metadata closer in the network topology to the point of playback, for instance at a social media site, a cable head end, a wireless provider's central office or at a content distribution network.

### Method of Associating Metadata with Media

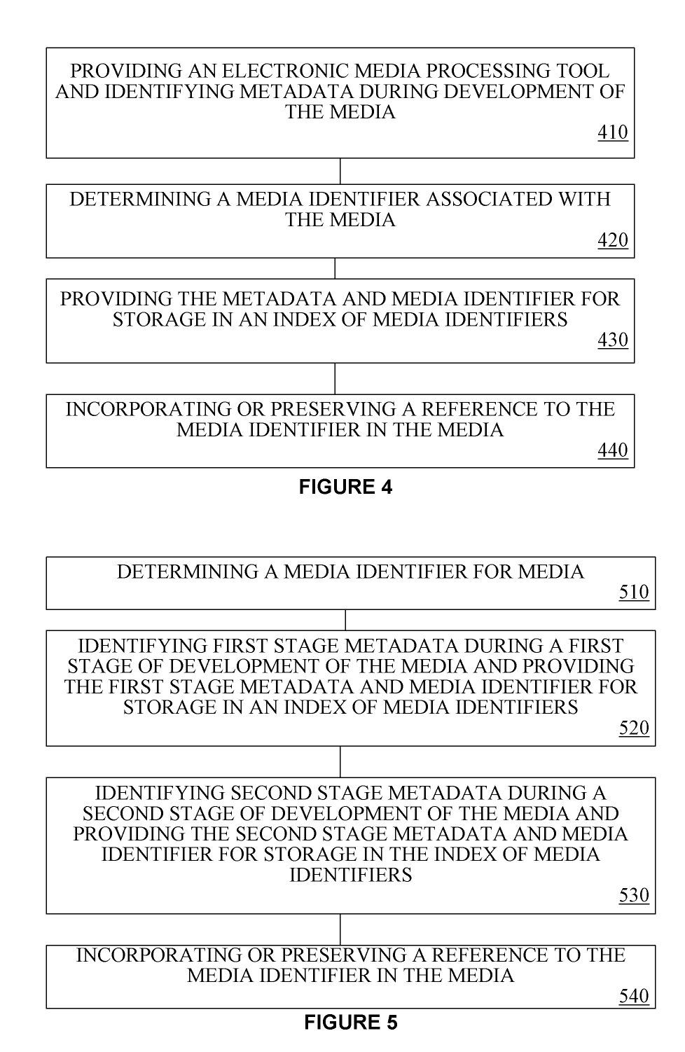

FIG. 4 is a flow chart illustrating a method of associating metadata with media according to certain embodiments. For purposes of illustration only, the elements of this method are described with respect to a particular implementation. A variety of other implementations are also possible.

In the method shown in FIG. 4, an electronic media processing tool is provided and metadata is identified during development of media, as shown in block 410. For example, with respect to the production workflow shown in FIG. 2, metadata may be identified during the creation stage 202. However, a variety of different techniques are used to develop media from multi-stage processes involving multiple users to single stage processes that are relatively simple. Generally, any activity occurring prior to playback of a piece of media may be considered development of the media for purposes of the present method.

In the method shown in FIG. 4, a media identifier associated with the media is determined, as shown in block 420. The media identifier may already be in existence, for example if the media has been imported from another processing tool, or may by newly created, for example for a new piece of media. The media identifier may be created by the processing tool, such as the first media processing tool 302 of FIG. 3, or may be provided by a media identifier generator located separately. The media identifier may be different from media identifiers associated with other media.

In the method shown in FIG. 4, the metadata and media identifier are provided for storage in an index of media identifiers, as shown in block 430. The index of media identifiers may be located remotely and provide a repository for metadata related to the media being developed as well as other media. The index of media identifiers may provide access to metadata associated with the media identifier, for example in response to requests that identify the media identifier.

One example of identifying metadata during development of media can be seen in the context of developing a movie. During development of a movie, a collaborative script writing tool may be used that allows multiple script writers to collaborate and otherwise contribute to the contents of a movie script. The collaborative script writing tool may give an identifier to the project and a related identifier to each version of a script, i.e., a new identifier each time the script is changed. Information about the development of the media, including information about each version of the script may be identified and stored as metadata for the media product. At a later stage of development, i.e., filming, an application may allow a camera to record clips to a laptop or other computing device as filming occurs. At the time of recording, metadata may also be created including, but not limited to, record time, location, props, costumes, or people in the scene. At that time or at a later stage of development, editing software may synchronize the original script with the recorded video.

Identifying metadata during development of the media may comprise capturing data during manipulation of an object, extracting text from one or more of a script, a teleprompter, or uncompressed audio speech, and/or importing or deriving metadata using any of a variety of known techniques. Identifying metadata during development of the media may also involve identifying metadata embedded in a source object used in development of the media. Other examples include capturing scene and character descriptions from a script, associating teleprompter text with video while recording, capturing title/artist/copyright information as MP3s are imported, extracting EXIF camera data as stills are loaded, and performing speech to text conversion from unmixed, uncompressed audio. Metadata may be identified automatically, based on user input, or as some combination of automatic and user identification.

Not all processing tools need be capable of using the metadata associated with a piece of media being developed. In addition, in some embodiments, a metadata entry in the metadata repository or database may include a version, tool, or stage number that identifies at which stage of development the referenced metadata is created or identified. Furthermore, a given piece of media may have more than one media identifier in some embodiments. For example, a piece of media may combine two or more previously created pieces of media such as two video clips. Each of these previously created video clips may have a media identifier and a new media identifier may be created to identify the new piece of media that combines the two clips. The metadata of the new piece of media may identify the source of the combined inputs, by identifying the media identifiers of each input. Similarly, metadata for each of the previously created clips may be created to identify that each was used as a source in the combined piece of media, e.g., by including a reference to the media identifier for the combined piece of media.

In the method shown in FIG. 4, the metadata and media identifier are provided for storage in an index of media identifiers, as shown in block 430. A metadata entry in such an index may comprise the media identifier and metadata associated with the media. The index of media identifiers may be a database, repository, area of local memory, or any other component capable of storing one or more metadata entries.

In the method shown in FIG. 4, a reference to the media identifier is incorporated or preserved in the media, as shown in block 440. The media identifier itself may be incorporated or preserved in the media. For example, if the media is a file, the media identifier may be incorporated as a watermark, as embedded metadata, as part of the content of the file itself, or otherwise. If the content is a signal, the media identifier may be incorporated as part of the signal, embedded in the signal, derived from the signal as a fingerprint, appended to one end of the signal, or otherwise incorporated. The media identifier need not change the file. For example, a fingerprint may be determined from the file and used as, or to create, a media identifier. In this case, simply preserving the file (or a relevant portion of the file) may ensure that the media will have the media identifier.

### Another Method of Associating Metadata with Media

FIG. 5 is a flow chart illustrating a method of creating metadata during media development according to certain embodiments. For purposes of illustration only, the elements of this method are described with respect to a particular implementation. A variety of other implementations are also possible.

In the method shown in FIG. 5, a media identifier associated with the media is determined, as shown in block 510. The media identifier may be different from media identifiers associated with other media. The media identifier may be created or derived by any device or component. In addition to the other examples described herein, a media identifier could be generated automatically by a development application upon the creation of a new development file or upon the occurrence of another user initiated event.

In the method shown in FIG. 5, first stage metadata is identified during a first stage of development of the media, and the first stage metadata and media identifier are provided for storage in an index of media identifiers, as shown in block 520. For example, if the first stage of development involves creating text for a presentation, one or more metadata entries could contain portions or all of the text. The metadata may also include the identity of authors of the text, the sources of statistics cited, the location of data related to the text, and any other development-related information. The index of media identifiers may provide access to metadata associated with the media in response to requests for metadata associated with a given media identifier.

In the method shown in FIG. 5, second stage metadata is identified during a second stage of development of the media, and the second stage metadata and media identifier are provided for storage in the index of media identifiers, as shown in block 530. At the second stage of development, metadata associated with development at the first stage may be retrieved using the media identifier. For example, in the presentation text example, the second stage of development may comprise using a presentation tool to develop graphics and charts to be incorporated with the presentation text. The metadata from the first stage may be retrieved and used at the second stage. For example, the location of data related to the text may be retrieved and the actual data used to generate a chart.

In the method shown in FIG. 5, a reference to a media identifier is incorporated or preserved in the media, as shown in block 540. The media identifier itself may be incorporated or preserved in the media. For example, if the media is a file, the media identifier may be incorporated as a watermark, as embedded metadata, as part of the content of the file itself, or otherwise. If the content is a signal, the media identifier may be incorporated as part of the signal, embedded in the signal, derived from the signal as a fingerprint, appended to one end of the signal, or otherwise incorporated. The incorporated or preserved media identifier can then be used by any application using the media to reference the metadata that has been associated with the media. The incorporated or preserved media identifier may also be used to add additional metadata at a later point, including post development.

### Method of Using a Metadata Repository

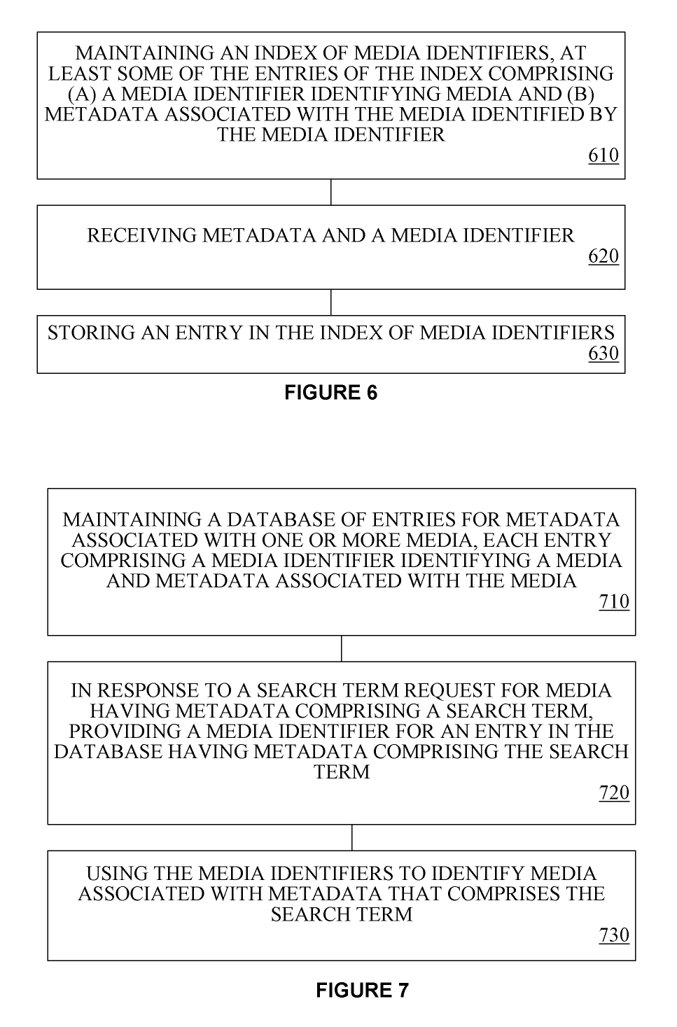

FIG. 6 is a flow chart illustrating a method of providing a repository of metadata according to certain embodiments. For purposes of illustration only, the elements of this method are described with respect to a particular implementation. A variety of other implementations are also possible.

In the method shown in FIG. 6, an index of media identifiers is maintained, as shown in block 610. At least some of the entries of the index may comprise (a) a media identifier identifying media and (b) metadata associated with the media identified by the media identifier. The metadata can, but need not, include information about the content of the media, the development of the media, rights in the media, and any other information related to the media. The index may be a database or other form of repository. The index may manage access and modification of the information it stores. For example, it may manage media identifier distribution and allow a user who has been provided a media identifier for a new piece of media to select whether others will be permitted to access, use, modify, or create entries in the index corresponding to that media identifier.

In the method shown in FIG. 6, metadata and a media identifier are received, as shown in block 620. The metadata may be associated with media developed on an electronic processing tool and may be received from the tool itself.

In the method shown in FIG. 6, an entry is stored in the index of media identifiers, as shown in block 630. The entry may comprise the metadata (e.g. the metadata received from the electronic media processing tool) and the media identifier.

The index of media identifiers may provide metadata to requesting entities. For example, metadata may be provided to a consumer of the media. As another example, the metadata may be provided to a content provider who wishes to identify the content of a piece of media (from its metadata) so that a contextually-related advertisement may be provided with the media. Additional uses of the metadata include other commonly known uses of embedded metadata and others that will be recognized by those of skill in the art.

### Method of Searching For Media

FIG. 7 is a flow chart illustrating a method of searching for media using a search term. For purposes of illustration only, the elements of this method are described with respect to a particular implementation. A variety of other implementations are also possible.

In the method shown in FIG. 7, a database is maintained of entries for metadata associated with one or more media, as shown in block 710. Generally, each entry comprises a media identifier identifying a piece of media and metadata associated with the piece of media. The database can manage access and modification of the information it stores. For example, it may identify some or all of the entries as searchable or identify, for a given entry, the identity of one or more parties that will have access to the entry as a searchable entry.

In the method shown in FIG. 7, in response to a search term request for media having metadata comprising a search term, media identifiers are provided for an entry or entries in the database having metadata comprising the search term, as shown in block 720. For example, an end user may use an Internet search engine to search for media comprising the term “CLAIRE BENNET.” The search engine may identify responses to the search at least in part by sending a search term request for media that accesses the database.

As shown in block 730, in response to a search term request for media having metadata comprising a search term, media identifiers are provided for the entry or entries in the database having metadata comprising the search term. In the case of a request from an Internet search engine, the entries in the database that comprise the search term could be returned to the search engine, for example by sending the search engine the media identifiers for the entry or entries. The search engine could use the media identifiers to identify the associated media and provide the requesting end user access to the media, for example by including the media in the search results provided to the end user. Alternatively, the media identifiers may be used at the database itself or at another device to identify the associated media and identify that media to the requesting search engine.

### General

Certain embodiments relate to an index of media identifiers that is available over the Internet. These are merely illustrative. For example, certain embodiments will not involve an index of media identifiers. Certain embodiments will not involve a development process and will simply involve storing metadata on a repository or other location using media identifiers. In short, the techniques for storing and using metadata and the other features described herein have uses in a variety of contexts, not to be limited by the specific illustrations provided herein. It should also be noted that embodiments may comprise systems having different architecture and information flows than those shown in the Figures. The systems shown are merely illustrative and are not intended to indicate that any system component, feature, or information flow is essential or necessary to any embodiment or limiting the scope of the present disclosure. The foregoing description of the embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

That which is claimed:

1. A method of associating metadata with media, the method comprising:
providing an electronic media processing tool for creating, modifying, or reviewing media;
identifying metadata during development of the media;
determining a media identifier associated with the media, the media identifier different from media identifiers associated with other media;
providing the metadata and media identifier for storage in an index of media identifiers, the index of media identifiers providing access to metadata associated with the media identifier; and
incorporating or preserving a reference to the media identifier in the media.

2. The method of claim 1, wherein the reference to the media identifier comprises the media identifier.

3. The method of claim 1, wherein incorporating or preserving the media identifier in the media comprises including the media identifier as embedded metadata in the media.

4. The method of claim 1, wherein incorporating or preserving the media identifier in the media comprises including the media identifier as a watermark in the media.

5. The method of claim 1, wherein incorporating or preserving the media identifier in the media comprises deriving a fingerprint from the media.

6. The method of claim 1, wherein the index of media identifiers comprises a database.

7. The method of claim 1, wherein identifying metadata during development of the media comprises capturing data during creation of an object.

8. The method of claim 1, wherein identifying metadata during development of the media comprises capturing data during manipulation of an object.

9. The method of claim 1, wherein identifying metadata during development of the media comprises extracting text from one or more of a script, a teleprompter, or audio speech.

10. The method of claim 1, wherein identifying metadata during development of the media comprises identifying metadata embedded in a source object used in development of the media.

11. A method of creating metadata during media development, the method comprising:
determining a media identifier associated with media being developed, the media identifier different from media identifiers associated with other media;
identifying first stage metadata during a first stage of development of the media and providing the first stage metadata and media identifier for storage in an index of media identifiers, the index of media identifiers providing access to metadata associated with the media identifier;
identifying second stage metadata during a second stage of development of the media and providing the second stage metadata and media identifier for storage in the index of media identifiers; and
incorporating or preserving a reference to the media identifier in the media.

12. The method of claim 11 further comprising, at the second stage of development, retrieving the first stage metadata using the media identifier.

13. The method of claim 11, wherein the first stage of development comprises development on a first electronic media processing tool and the second stage of development comprises development on a different electronic media processing tool.

14. A method of accessing metadata associated with media, comprising:
retrieving a media identifier from media;
sending a request for metadata to a media identifier index, the request comprising the media identifier; and
receiving metadata associated with the media identifier from the media identifier index.

15. The method of claim 13 further comprising using the metadata to determine an advertisement and providing the media and advertisement together.

16. A method of providing a repository of metadata, the method comprising:
maintaining an index of media identifiers, at least some of the entries of the index comprising (a) a media identifier identifying media and (b) metadata associated with the media identified by the media identifier;
receiving metadata associated with media; and
storing an entry in the index of media identifiers, the entry comprising the metadata associated with the media and a media identifier associated with the media.

17. The method of claim 16 further comprising generating the media identifier associated with the media, the media identifier different from media identifiers associated with other media.

18. A method of providing a repository of metadata, the method comprising:
maintaining an index of media identifiers, at least some of the entries of the index comprising (a) a media identifier identifying media and (b) metadata associated with the media identified by the media identifier;
receiving metadata from an electronic media processing tool, the metadata associated with media developed on the electronic processing tool; and
storing an entry in the index of media identifiers, the entry comprising the metadata from the electronic media processing tool and a media identifier associated with the media developed on the electronic processing tool.

19. The method of claim 18 further comprising, providing metadata from the entry in response to a request for metadata, the request comprising the media identifier associated with the media developed on the electronic processing tool.

20. The method of claim 19, further comprising providing metadata from multiple entries, each entry of the multiple entries comprising the media identifier.

21. A system comprising:
a database comprising an index of media identifiers, at least some of the entries of the index comprising (a) a media identifier identifying media and (b) metadata associated with the media identified by the media identifier;
a receiving component for receiving a media identifier identifying media and metadata associated with the media identified by the media identifier; and
a storage component for storing entries in the index of media identifiers, stored entries comprising a media identifier identifying media and metadata associated with the media identified by the media identifier.

22. The system of claim 21, wherein the receiving component receives metadata created during development on an electronic processing tool.

23. The system of claim 21 further comprising a media identifier generating component for generating a new media identifier, the new media identifier different from media identifiers associated with other media.

24. A method of searching for media using a search term, the method comprising:
maintaining a database of entries for metadata associated with one or more media, entries of the database comprising a media identifier corresponding to a media and metadata associated with the media, the media identifier different from media identifiers associated with other media;
in response to a search term request for media having metadata comprising a search term, providing a media identifier for an entry in the database having metadata comprising the search term; and
using the media identifier to identify media associated with metadata that comprises the search term.

25. A computer-readable medium on which is encoded program code, the program code comprising:
program code for providing an electronic media processing tool for creating, modifying, or reviewing media;
program code for identifying metadata during development of the media;
program code for determining a media identifier associated with the media, the media identifier different from media identifiers associated with other media;
program code for providing the metadata and media identifier for storage in an index of media identifiers, the index of media identifiers providing access to metadata associated with the media identifier; and
program code for incorporating or preserving a reference to the media identifier in the media.

26. A computer-readable medium on which is encoded program code, the program code comprising:
program code for maintaining an index of media identifiers, at least some of the entries of the index comprising (a) a media identifier identifying media and (b) metadata associated with the media identified by the media identifier;
program code for receiving metadata associated with media; and
program code for storing an entry in the index of media identifiers, the entry comprising the metadata and a media identifier associated with the media.
